(19) United States
(12) Patent Application Publication
(10) Pub. No.: US 2008/0227880 A1
(43) Pub. Date: Sep. 18, 2008

(54) Porous body and filter

(75) Inventors: Hiroyuki YOSHIMOTO, Osaka (JP); Hirokazu Yukawa, Osaka (JP); Yasuhiko Sawada, Osaka (JP); Taku Yamanaka, Osaka (JP); Masamichi Sukegawa, Osaka (JP)

Correspondence Address: SUGHRUE MION, PLLC, 2100 PENNSYLVANIA AVENUE, N.W., SUITE 800, WASHINGTON, DC, 20037, US

(73) Assignee: DAIKIN INDUSTRIES, LTD., Osaka-Shi (JP)

(21) Appl. No.: 12/047,370

(22) Filed: Mar. 13, 2008

(30) Foreign Application Priority Data
Mar. 13, 2007 (JP) 2007-064002

(51) Int. Cl. C08J 9/00

(52) U.S. Cl. 521/134

(57) ABSTRACT

The present invention provides a molded porous body with very small air bubbles distributed therein as well as a filter using the porous body. The present invention is related to a porous body comprising a polytetrafluoroethylene-based resin and a thermoplastic resin other than the polytetrafluoroethylene-based resin, and having a specific gravity exceeding 1.80 but less than 2.18 and a percent conversion to crystals of not higher than 50%.

### TECHNICAL FIELD

The present invention relates to a porous body and a filter.

### BACKGROUND ART

Fluororesins are generally excellent in thermal stability, chemical resistance, nonstickiness, flame retardancy and mechanical strength, among others, and when they are molded into porous bodies, the porous bodies can be used as very stable and highly durable filters.

The fluororesin-made porous bodies so far proposed are manufactured by baking preforms prepared by press molding of a sintered polytetrafluoroethylene powder or a mixture of a sintered polytetrafluoroethylene powder and 1% by weight of a tetrafluoroethylene/perfluoro (vinyl ether) copolymer powder (cf. e.g. Patent Document 1).

However, such polytetrafluoroethylene resin-made porous bodies are obtained by using a presintered and cured polytetrafluoroethyletne powder and carrying out the pressing on the occasion of preforming at such a level that the powder particles will not be completely broken and by uniting the powder particles together at the points of contact among them by baking; this technique is quite different from the idea of the present invention, which will be described later herein.

[Patent Document 1] Japanese Kokai Publication S61-66730

### DISCLOSURE OF INVENTION

### Problems which the Invention is to Solve

In view of the above-discussed state of the art, the present invention provides a molded porous body with very small air bubbles distributed therein as well as a filter using the porous body.

### Means for Solving the Problems

The present invention provides a porous body comprising a polytetrafluoroethylene-based resin and a thermoplastic resin other than the polytetrafluoroethylene-based resin, and having a specific gravity exceeding 1.80 but less than 2.18 and a percent conversion to crystals of not higher than 50%.

The invention also provides a filter using the above porous body.

In the following, the invention is described in detail.

The porous body of the invention has a specific gravity exceeding 1.80 but less than 2.18 and a percent conversion to crystals of not higher than 50%. The porous body of the invention, which satisfies these physical property requirements, contains a large number of voids, which are open or interconnected cells and have an average air bubble size of several micrometers, and is very useful in the field of application as a filter.

The porous body of the invention has a specific gravity exceeding 1.80 but less than 2.18. If the specific gravity is 2.18 or higher, the porous body may be inferior in gas permeability. From the mechanical strength viewpoint, the specific gravity is preferably not lower than 0.9. The specific gravity is preferably above 1.80 since minute pores can be obtained then.

The porous body of the invention has a percent conversion to crystals of not higher than 50%. If the percent conversion to crystals is above 50%, the gas permeability may be inferior in some cases. From the viewpoint of attaining excellent gas permeability, the percent conversion to crystals is preferably not higher than 35%. The percent conversion to crystals is calculated in the following manner.

An amount of 10.0±0.1 mg of the porous body of the invention is cut out and weighed for use as a specimen. The modification of the resin upon heating proceeds from the surface of the porous body to the inside thereof, so that care should be taken on the occasion of taking the specimen so that the specimen may comprise portions differing in degree of modification in a balanced manner, as seen in the direction of thickness of the porous body. A specimen, weighing 10.0±0.1 mg, of a preform in an unbaked state prior to heat treatment is prepared in the same manner. Using these specimens, the crystal melting curves are first measured by the following method.

The crystal melting curve is recorded using a DSC (differential scanning calorimeter; Perkin Elmer model DSC-2). First, the unbaked preform specimen is placed on the aluminum pan of the DSC and the heat of fusion of the unbaked preform and the heat of fusion of the baked body obtained by heating the preform to a temperature not lower than the melting point of the PTFE-based resin (heat of fusion of the baked presintered preform) are measured according to the following procedure.

(1) Each specimen is heated to 277° C. at a rate of heating of 160° C./minute and then heated from 277° C. to 360° at a heating rate of 10° C./minute. An example of the crystal melting curve recorded in this heating step is shown in FIG. 1. The position of the endothermic peak appearing in this heating step is defined at the “melting point of the preform” or “melting point of the resin powder”.

(2) After heating to 360° C., the specimen is cooled to 277° C. at a cooling rate of 80° C./minute.

(3) The specimen is again heated to 360° C. at a heating rate of 10° C./minute. An example of the crystal melting curve recorded in the heating step (3) is shown in FIG. 2. The position of the endothermic peak recorded in the heating step (3) is defined as the “melting point of the presintered preform-derived baked product”.

The melting point of the preform and the melting point of the presintered preform-derived baked product are each proportional to the area between the endothermic curve and the baseline. The baseline is a straight line drawn, on the DSC chart, from the point at 307° C. to the right end base of the endothermic curve.

Then, the crystal melting curve of the porous body of the invention is recorded according to the above step (1). An example of the curve recorded in this case is shown in FIG. 3.

The percent conversion to crystals is calculated using the following formula (A).

Percent conversion to crystals=(S1−S3)/(S1−S2) (A)

In the above formula (A), S1 is the endothermic curve area for the preform, S2 is the endothermic curve area for the presintered preform-derived baked product, and S3 is the endothermic curve area for the porous body of the invention.

The porous body of the invention comprises polytetrafluoroethylene [PTFE]-based resin and a thermoplastic resin other than the PTFE-based resin.

The above porous body preferably comprises 10 to 95% by mass of the above PTFE-based resin and 90 to 5% by mass of the thermoplastic resin. The proportions of both the resins are determined taking into consideration the desired gas permeability, maximum strength and elongation, among others.

When the PTFE-based resin content is below 10% by mass, however, voids hardly tend to form connected air bubbles, hence the gas permeability may become poor. When the content of the thermoplastic resin is below 5% by mass, the porous body may be poor in mechanical strength.

The PTFE-based resin, which should be non-melt-processable, may be a tetrafluoroethylene [TFE] homopolymer or modified polytetrafluoroethylene [modified PTFE]. As the modified PTFE, there may be mentioned perfluoro(alkyl vinyl ether)-modified PTFE and hexafluoropropylene-modified PTFE, among others. The modified PTFE preferably has a minute-quantity monomer unit content of 0.01 to 1% by mass based on all monomer units. The above PTFE-based resin preferably has no experience of heat treatment at the melting point or a higher temperature.

The above PTFE-based resin preferably has a melting point of 320° C. or higher from the mechanical strength and thermal stability viewpoint. The melting point is more preferably not lower than 327° C. and preferably not higher than 345° C. The melting point, so referred to herein, is the temperature corresponding to the maximum melting peak value recorded using a Seiko model differential scanning calorimeter at a programming rate of 10° C./minute.

The above PTFE-based resin preferably has a melt flow rate [MFR] of not higher than 1 g/10 minutes. When the MFR is in excess of 1 g/10 minutes, the porous body may become inferior in surface smoothness.

The MFR, so referred to herein, is the value determined in the following manner. A melt indexer (product of Toyo Seiki) equipped with a corrosion-resistant cylinder, die and piston in accordance with ASTM D 1238-95 is used. The cylinder is maintained at 372±1° C. and is charged with 5 g of the sample powder and, after 5 minutes of retention therein, the melt is extruded through the die orifice under a load of 5 kg (piston plus weight). The rate of extrusion (g/10 minutes) on that occasion is determined as the MFR.

For the porous body to be excellent in mechanical strength, the thermoplastic resin mentioned above preferably comprises at least one species selected from the group consisting of tetrafluoroethylene/hexafluoropropylene copolymers [FEPs], tetrafluoroethylene/perfluoro(alkyl vinyl ether) copolymers [PFAs], poly(vinylidene fluoride) [PVdF], ethylene/tetrafluoroethylene copolymers [ETFEs], ethylene/tetrafluoroethylene/hexafluoropropylene copolymers [EFEPs], polypropylene [PP] and polyethylene [PE].

More preferred as the thermoplastic resin are melt-processable fluororesins from the viewpoint that the porous body can be improved in thermal stability and can be used stably at relatively high temperatures. The melt-processable fluororesins include, among others, FEPs, PFAs, PVdF, ETFEs and EFEPs, and FEPs and PFAs are still more preferred.

As the PFAs, there may be mentioned tetrafluoroethylene/perfluoro(methyl vinyl ether) copolymers and tetrafluoroethylene/perfluoro(propyl vinyl ether) copolymers, among others.

The PTFE-based resin and thermoplastic resin can be produced by any method known in the art, for example by emulsion polymerization, suspension polymerization or solution polymerization. Those produced by emulsion polymerization are preferred from the easy paste extrusion viewpoint.

When the PTFE-based resin and thermoplastic resin are produced by emulsion polymerization, they generally have an average primary particle diameter of about 0.02 to 0.5 μm. A preferred lower limit to the average primary particle diameter is 0.1 μm, and a preferred upper limit thereto is 0.3 μm. The average primary particle diameter is the value obtained by the gravity sedimentation method.

The thermoplastic resin preferably has a melting point lower than the melting point of the PTFE-based resin. From the mechanical strength, thermal stability and moldability points of view, it preferably has a melting point of 100 to 325° C. From the mechanical strength and thermal stability viewpoint, the melting point is more preferably not lower than 150° C. and, from the mechanical strength and moldability viewpoint, it is more preferably not higher than 315° C.

The thermoplastic resin preferably has a melt flow rate [MFR] of not higher than 70 g/10 minutes. At MFR levels exceeding 70 g/10 minutes, poor mechanical strength may result. The MFR is more preferably not lower than 50 g/10 minutes.

The porous body of the invention can be produced by mixing up the polytetrafluoroethylene-based resin and a thermoplastic resin other than the polytetrafluoroethylene-based resin, molding the mixture and subjecting the thus-obtained preform to heat treatment.

As the method of mixing, there may be mentioned, for example, (i) the dry mixing method comprising mixing up the PTFE-based resin in powder form and the thermoplastic resin in powder form, (ii) the cocoagulation method comprising adding one of the PTFE-based resin and thermoplastic resin in powder form to an aqueous dispersion of the other, followed by coagulation, and (iii) the cocoagulation method comprising mixing up an aqueous dispersion of the PTFE-based resin and an aqueous dispersion of the thermoplastic resin, followed by coagulation.

Among the methods mentioned above, the cocoagulation method mentioned above under (ii) or (iii) is preferred, and the cocoagulation method (iii) is more preferred, since such method enables sufficient mixing and leads to production of porous bodies which are homogeneous and excellent in mechanical strength and electrical characteristics.

The above-mentioned cocoagulation method (iii) preferably comprises mixing up the aqueous dispersion containing the PTFE-based resin particles as produced by polymerization and the aqueous dispersion of the thermoplastic resin particles as produced by polymerization and then causing a coagulant, such as an inorganic acid or a metal salt thereof, to act on the mixed dispersion to cause cocoagulation.

The mixture obtained by mixing up the PTFE-based resin and thermoplastic resin preferably comprises 10 to 95% by mass of the PTFE-based resin solid matter and 90 to 5% by mass of the thermoplastic resin solid matter. The mixing ratio is determined taking into consideration the desired gas permeability, maximum strength and elongation, among others. When, however, the PTFE-based resin content is below 10% by mass, voids hardly form connected air bubbles, resulting in poor gas permeability. When the thermoplastic resin content is below 5% by mass, the porous body may be inferior in mechanical strength.

For sufficient mixing of the PTFE-based resin with the thermoplastic resin, hence for easy preparation of a homogeneous mixture, it is more preferred that the average particle diameter of the PTFE-based resin particles and the average particle diameter of the thermoplastic resin particles be approximately equal to each other.

The above mixture may further comprise, in addition to the PTFE-based resin and thermoplastic resin, one or more extrusion aids and/or additives known in the art for the purpose of improving the moldability/processability and/or improving the physical properties of the product porous body.

In the case of paste extrusion, which is to be described later herein, an extrusion aid is preferably added, preferably in an amount of 10 to 25% by mass relative to the sum of the PTFE-based resin and thermoplastic resin. Preferred as the extrusion aid are hydrocarbon type solvents.

Usable as the additive or additives other than the extrusion aids are antioxidants, pigments or dyes, fillers and blowing agents, among others. As examples, there may be mentioned carbon black, graphite, spherical carbon, alumina, mica, silicon carbide, boron nitride, titanium oxide, bismuth oxide, zinc oxide, tin oxide, bronze, gold, silver, copper and nickel, each in powder form, and fiber powders. Minute polymer particles other than the resins mentioned above, and other components may be admixed with the resin mixture provided that they will not defeat the object of the invention. The additives other than the extrusion aids may be added in the step of mixing up the PTFE-based resin and thermoplastic resin.

In producing the porous body of the invention, the mixture of the PTFE-based resin and thermoplastic resin, after preparation thereof, is molded to give a preform. The method of molding the preform is not particularly restricted but may be selected, according to the intended use of the porous body, from among such known methods as compression molding, extrusion molding, extrusion/covering molding, wrapping tape molding and calendering, although paste extrusion molding is preferred among others.

Paste extrusion molding makes it possible to lower the specific gravity of the molded article to 2.0 or below. It also makes it possible to produce a molded body having a specific gravity exceeding 1.8 by adjusting the proportion of the extrusion aid. Thus, it is a method best suited for preform molding. The molded body prepared by paste extrusion molding and having a specific gravity exceeding 1.8 but lower than 2.18 becomes a porous body having uniform pores with a pore diameter of 0.6 micron or smaller. It is difficult to obtain the porous body of the invention by the methods other than paste extrusion molding, for example by melt molding.

On the occasion of the above-mentioned molding, heating may be made. The heating temperature, which may vary according to the PTFE-based resin and thermoplastic resin species employed, is preferably lower than the melting point of the thermoplastic resin.

The porous body of the invention is obtained by subjecting the preform obtained by molding in the above manner to heat treatment, and the heat treatment is carried out at a temperature lower than the melting point of the PTFE-based resin but not lower than the melting point of the thermoplastic resin having a lowest melting point among the thermoplastic resins. So long as the heat treatment temperature is within the above range, the PTFE-based resin is not yet baked, hence is low in density and soft, while the thermoplastic resin is once melted and then solidifies, so that the porous body obtained has minute voids and at the same time is excellent in mechanical strength.

The temperature in carrying out the above heat treatment is preferably within the range of the temperature which is the mean between the melting point of the PTFE-based resin and the melting point of the resin having a lowest melting point among the thermoplastic resins ±50° C. The temperature in carrying out the above heat treatment is preferably 100 to 325° C., more preferably 150 to 315° C.

In producing the porous body of the invention, the production method preferably comprises a drawing step following the heat treatment step. When the production method of the porous body comprises a drawing step, the PTFE-based resin can be drawn in an unbaked state, so that the air bubble size can be further reduced and a filter suited for the intended use can be obtained. The drawing may be carried out in the conventional manner, for example by roll drawing. The drawing conditions are not particularly restricted but the temperature on the occasion of drawing may be adjusted to 100 to 325° C. and the draw ratio at 2 to 60.

A filter using the porous body of the invention is used therein also constitutes an aspect of the invention. The filter, in which the porous body of the invention is used, may be such that it passes air but hardly passes water. The filter can be suitably used as an oxygen-enriching membrane or gas-liquid separation membrane, among others.

The filter of the invention may have a cylindrical or sheet-like form. As regards the method of using the filter of the invention, the filtering action is utilized by causing a fluid to pass through the filter molded in the form of a tube from the tube inside to the outside or vice versa, or the filtering action is utilized by causing a fluid to flow through the filter molded in a rod-like (cylindrical) form and placed in a tube in the direction parallel to the center line of the cylinder, or the filtering action is utilized in the planar form by compression molding/processing of the filter into a sheet-like form. Alternatively, a tubular form may be molded and sliced to give rings for use as oil-impregnated bearings, for instance.

### EFFECTS OF THE INVENTION

The porous body of the invention, which has the constitution described hereinabove, has very small air bubbles distributed therein and is excellent in mechanical strength as well and can be suitably used as a filter.

The filter of the invention, in which the porous body of the invention is used, may be such that it passes air but hardly passes water; therefore, it is particularly excellent as a filter.

### BEST MODES FOR CARRYING OUT THE INVENTION

The following examples and comparative examples illustrate the present invention more specifically. The values given in the examples and comparative examples were measured by the following methods.

Measurement of percent conversion to crystals

Specimens were prepared from the cylindrical molded bodies and porous bodies obtained in the examples and measurements were made by the method described hereinabove.

Criteria for judging PTFE as to baked, semi-baked or unbaked condition

(1) Baked: There is a peak at 327° C.±2° and there is no peak within the range of 330° C. to 350° C.

(2) Semi-baked: There is a peak at 327° C.±20 and there is also a peak within the range of 330° C. to 350° C.

(3) Unbaked: There is no peak at 327° C.±2° and there is a peak within the range of 330° C. to 350° C.

### EXAMPLE 1

A 2739 g-portion of an aqueous dispersion (resin content 35.1% by mass) of perfluoro(propyl vinyl ether)-modified PTFE (SSG: 2.175) and 2034 g of an aqueous dispersion (resin content 11.8% by mass) of PFA were mixed up, and coagulation was caused. The subsequent washing and drying (160° C., 18 hours) gave a mixed powder. This was mixed with an amount of 16% by mass, based on the mixed powder, of Isopar G, a hydrocarbon solvent. The mixture was extruded using a paste molding machine. The subsequent molding aid drying/removal and baking gave a cylindrical molded article. The paste extruder had a mold inside diameter of 3.5 mm, the temperature in the baking oven as set was 330° C., and the porous body finished had a cylindrical form with a diameter of 2.8 mm. Upon heat absorption confirmation using a differential scanning calorimeter (DSC), the porous body showed two peaks at 334° C. and 310° C., indicating that PTFE was in an unbaked state and PFA was in a state once baked. The porous body finished had a specific gravity of 1.83 and a percent conversion to crystals of 2%.

This porous body having a diameter of 2.8 mm was cut to a length of 10 mm and the cut piece was inserted into a stainless steel tube with an inside diameter of 3.0 mm to give a filter. This filter was measured for pore size using a Coulter porometer under application of an air pressure. The pore size was 0.2 μm and the air pressure was 0.21 MPa.

### EXAMPLE 2

A 3103 g-portion of an aqueous dispersion (resin content 29% by mass) of hexafluoropropylene-modified PTFE and 834 g of an aqueous dispersion (resin content 18% by mass) of FEP were mixed up, and coagulation was caused. The subsequent washing and drying (160° C., 18 hours) gave a mixed powder. This was mixed with an amount of 16% by mass, based on the mixed powder, of Isopar G, a hydrocarbon solvent. The mixture was extruded using a paste molding machine. The subsequent molding aid drying/removal and baking gave a tubular porous body. The paste extruder had a mold inside diameter of 3.5 mm, and a stainless tube with a diameter of 1.48 mm was used as a core pin. The temperature in the baking oven as set was 330° C., and the porous body finished had a tubular form with an outside diameter of 2.8 mm and an inside diameter of 1.2 mm. Upon heat absorption confirmation using a DSC, the porous body showed two peaks at 352° C. and 341° C., indicating that PTFE was in an unbaked state and FEP was in a state once baked. The porous body finished had a specific gravity of 1.81 and a percent conversion to crystals of 4%.

This porous body having a diameter of 2.8 mm was cut to a length of 10 mm and the cut piece was inserted into a stainless steel tube with an inside diameter of 3.0 mm to give a filter. This filter was measured for pore size using a Coulter porometer under application of an air pressure. The pore size was 0.2 μm and the air pressure was 0.25 MPa.

### EXAMPLE 3

A 2307 g-portion of an aqueous dispersion (resin content 35.1% by mass) of perfluoro (propyl vinyl ether)-modified PTFE and 2288 g of an aqueous dispersion (resin content 11.8% by mass) of PFA were mixed up and, after further addition of 100 g of carbon fibers (Kureha Chemical's M2007S), coagulation was caused. The subsequent washing and drying (160° C., 18 hours) gave a mixed powder. This was mixed with an amount of 15% by mass, based on the mixed powder, of Isopar G, a hydrocarbon solvent. The mixture was extruded using a paste molding machine. The subsequent molding aid drying/removal and baking gave a cylindrical molded article. The paste extruder had a mold inside diameter of 3.5 mm, the temperature in the baking oven as set was 330° C., and the porous body finished had a cylindrical form with a diameter of 2.8 mm. Upon heat absorption confirmation using a differential scanning calorimeter (DSC), the porous body showed two peaks at 334° C. and 310° C., indicating that PTFE was in an unbaked state and PFA was in a state once baked. The porous body finished had a specific gravity of 1.82 and a percent conversion of PTFE to crystals of 2%.

This porous body having a diameter of 2.8 mm was cut to a length of 10 mm and the cut piece was inserted into a stainless steel tube with an inside diameter of 3.0 mm to give a filter. This filter was measured for pore size using a Coulter porometer under application of an air pressure. The pore size was 0.2 μm and the air pressure was 0.25 MPa.

### EXAMPLE 4

A porous body was obtained in the same manner as in Example 1 except that the baking temperature was 338° C. The porous body had a specific gravity of 2.05 and a percent conversion to crystals of 31%, and had a cylindrical shape with a diameter of 2.55 mm.

Upon heat absorption confirmation using a differential scanning calorimeter (DSC), the porous body showed three peaks at 310° C., 327° C. and 334° C., indicating that PTFE was in a semi-baked state. Upon Coulter porometer measurement, the pore diameter was found to be 0.5 μm and the air pressure was 0.65 MPa.

### COMPARATIVE EXAMPLE 1

A 2739 g-portion of an aqueous dispersion (resin content 35.1% by mass) of PTFE and 2034 g of an aqueous dispersion (resin content 11.8% by mass) of PFA were mixed up, and coagulation was caused. The subsequent washing and drying (160° C., 18 hours) gave a mixed powder. This was mixed with an amount of 16% by mass, based on the mixed powder, of Isopar G, a hydrocarbon solvent. The mixture was extruded using a paste molding machine. The subsequent molding aid drying/removal and baking gave a cylindrical molded article. The paste extruder had a mold inside diameter of 3.5 mm, the temperature in the baking oven as set was 380° C., and the porous body finished had a cylindrical form with a diameter of 2.6 mm. Upon heat absorption confirmation using a differential scanning calorimeter (DSC), the porous body showed two peaks at 327° C. and 310° C., indicating that PTFE and PFA were each in a state once baked. The porous body finished had a specific gravity of 2.18 and a percent conversion to crystals of 99%.

The molded article obtained was cut and the section was observed under a microscope with a magnification of 100; almost no voids could be confirmed.

### INDUSTRIAL APPLICABILITY

The porous body of the invention can be suitably utilized in the field of application as a filter. The filter of the invention can be suitably used as an oxygen-enriching membrane or gas-liquid separation membrane, for instance.

### BRIEF DESCRIPTION OF THE DRAWINGS

FIG. 1 This shows an example of the DSC crystal melting curve in the step of heating the preform to be subjected to measurement of the percent conversion to crystals.

FIG. 2 This shows an example of the DSC crystal melting curve in the step of heating the baked preform to be subjected to the measurement of the percent conversion to crystals.

FIG. 3 This shows an example of the DSC crystal melting curve in the step of heating the porous body to be subjected to measurement of the percent conversion to crystals.

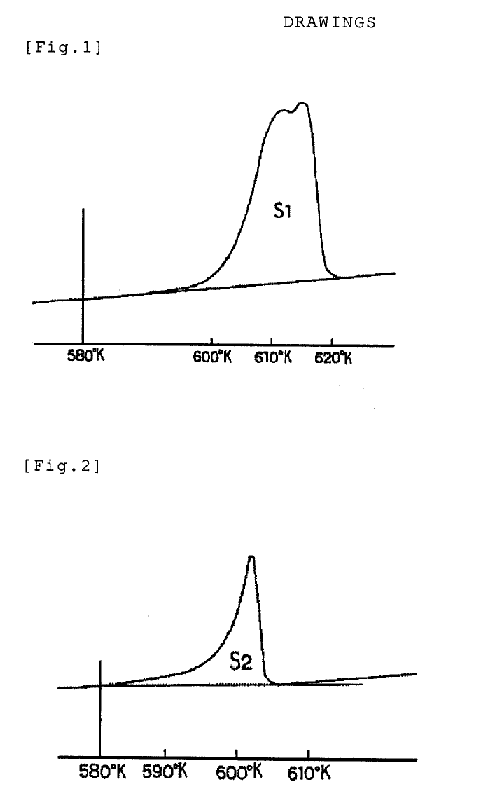

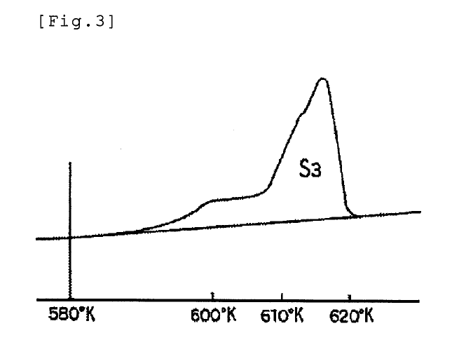

1. A porous body comprising a polytetrafluoroethylene-based resin and a thermoplastic resin other than said polytetrafluoroethylene-based resin,
and having a specific gravity exceeding 1.80 but less than 2.18 and a percent conversion to crystals of not higher than 50%.

2. The porous body according to claim 1,
wherein the thermoplastic resin comprises at least one species selected from the group consisting of tetrafluoroethylene/hexafluoropropylene copolymers, tetrafluoroethylene/perfluoro(alkyl vinyl ether) copolymers, poly(vinylidene fluoride), ethylene/tetrafluoroethylene copolymers, ethylene/tetrafluoroethylene/hexafluoropropylene copolymers, polypropylene and polyethylene.

3. A filter using the porous body according to claim 1.
